(19) United States
(12) Patent Application Publication
(10) Pub. No.: US 2004/0036253 A1
(43) Pub. Date: Feb. 26, 2004

(54) Motorcycle structure

(76) Inventor: Chih-Hung Cheng, Kaohsiung (TW)

Correspondence Address: Leong C. LEI, PME # 1008, 1867 Ygnacio Valley Road, Walnut Creek, CA, 94598-3214, US

(21) Appl. No.: 10/224,349

(22) Filed: Aug. 21, 2002

(51) Int. Cl. B62H 1/00

(52) U.S. Cl. 280/293

(57) ABSTRACT

The present invention relates to an improved motorcycle structure, comprising a front wheel, a back wheel, an engine, and a frame body; wherein the frame body having a left horizontal frame and a right horizontal frame, each of the horizontal frames having an aslant pipe coupled backward to the horizontal frames; a side wheel unit being set on each of the external side of the front wheel and the back wheel, further comprising a connecting device, a contractible supporting base, and a side wheel; the connecting device is for pivotally connecting the contractible supporting base and the horizontal frame, and using a sliding axle to pass through the components of the horizontal frame, and in the meantime passing through and coupling to a bushing corresponsive to contractible supporting base. The side wheel is pivotally coupled to the external side of the contractible supporting base; the contractible supporting base has at least one contractible rod such that the bottom and the top of the contractible rod are pivotally coupled onto the surface of the contractible supporting base and onto the frame body. Such arrangement mainly makes use of the erection assistance and the contraction functions of the side wheel unit, so that motorcycle riders can drive or make turns on a rough road surface more safely and stably.

### BACKGROUND OF THE INVENTION

(a) Field of the Invention

The present invention relates to an improved motorcycle structure, more particularly to the structure of a side wheel unit having the functions of assisting the erection of the motorcycle and the contractible functions to enhance the safety and stability of riding a motorcycle.

(b) Description of the Prior Art

The conventional motorcycle comprises a front wheel, a back wheel, and a dynamic source (such as an engine or electric motor); mainly makes use of the front and back wheels for the driving. When the motorcycle rider makes a turn or drives on a rough road surface, the body of the motorcycle may be shaken and unstable, or even may have the risk of toppling over or falling. Furthermore, those who have ridden a motorcycle in the rain fully recognize that it needs to stand on the ground with a foot when the motorcycle is stopped in front of a stop sign or red light in order to maintain the balance. However, if the road surface is wet, it may get the shoes all wet, which is very inconvenient. Further, the improved motorcycle for handicaps adds two additional side wheels on the axle of the back wheel for the balance. It is difficult to make such kind of remodeling, in addition to its higher cost. The present inventor thought of a way of installing an additional side wheel on each side of the frame body instead of installing them on the back wheel, and incorporating the function of contraction. It does not just enhance the stability by four wheels, but also can make adjustment to different road conditions by the contractible function. It enhances the stability of the vehicle body suitable for the riding of regular riders, and also suitable for handicaps by simply adding the wheels to the existing frame body of the motorcycle.

The innovation of the improved motorcycle structure resides on the side wheel unit that is disposed on the external side of the left horizontal frame and right horizontal frame on the bottom side of the frame body; such side wheel unit comprising a connecting device, a contractible supporting base, and a side wheel; the connecting device is for coupling the contractible supporting base and the horizontal frame, and makes use of a sliding axle to pass through the holes of the front and back fixing bases and the adjusting base on the horizontal frame, and also passes through the bushing of the contractible supporting base at the same time; the coupling of the contractible supporting base and the side wheel uses a connecting axle to pass through the through hole in the protruded member of the contractible supporting base and come out from the through hole of the side wheel, and the front end is fixed by screw. The protruded member of the contractible supporting base is used for pivotally coupling the side wheel; additionally it mainly pivotally couples to the bottom of the contractible supporting base, and the top of the contractible rod is coupled onto the frame body of the motorcycle; wherein the coupling of the contractible rod, contractible supporting base, and frame body makes use of a screw bolt to pass through the two protruding brackets having a through hole corresponsive to the contractible rod. Further, an upper and a lower connecting frames are coupled by welding at the position between two sides of the frame body and between the left and right horizontal frames, and a curved pipe is used for the welding on both sides. The two protruded brackets pivotally coupled to the front end of the contractible rod proximate to the curved tube of the upper connecting base.

### SUMMARY OF THE INVENTION

The primary objective of the present invention is to add a pair of side wheels to the horizontal frame on both sides of the side wheel unit, so that the side wheel unit has the function of assisting the erection. In addition, the coupling of the contractible rod between the frame body makes the motorcycle more applicable for driving on the road surface of different conditions, which can be implemented to the current existing motorcycle to enhance the function of current motorcycle.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a diagram of a preferred embodiment of the present invention.

FIG. 2 is a blow up diagram of a preferred embodiment of the present invention.

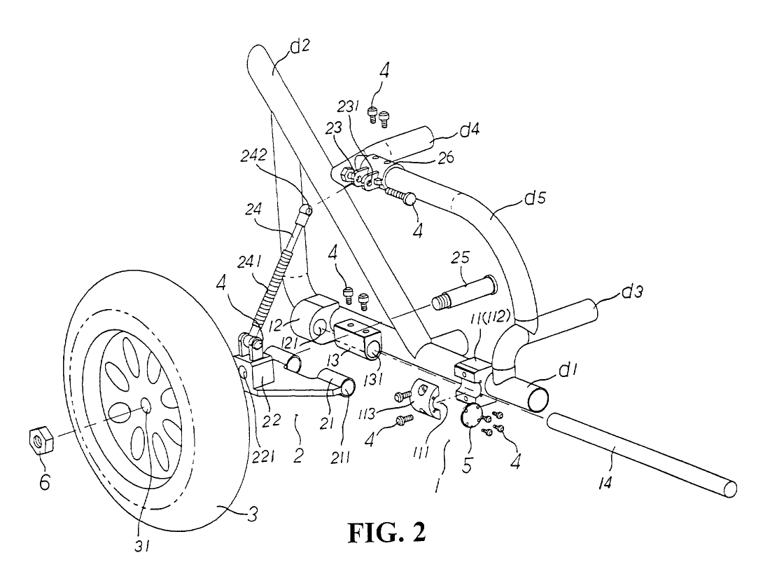

FIG. 3 is a diagram of the assembly of a preferred embodiment of the present invention.

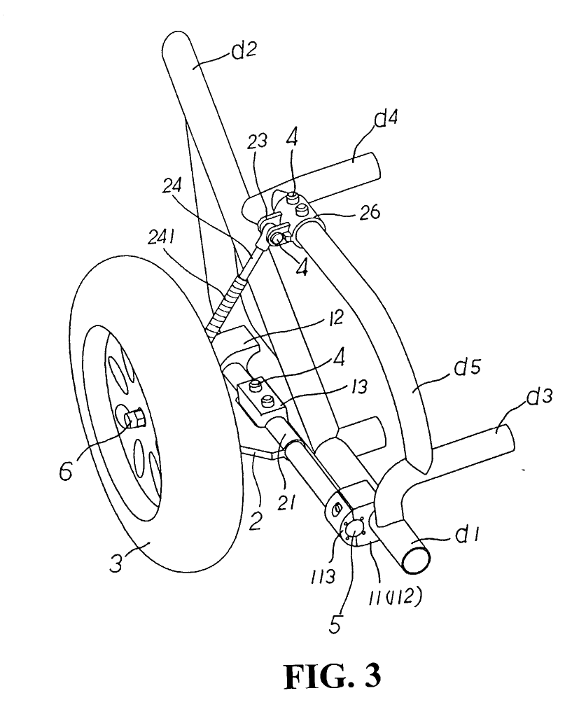

FIG. 4 is a front-view diagram of a preferred embodiment of the present invention.

FIG. 5 is a top-view diagram of a preferred embodiment of the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

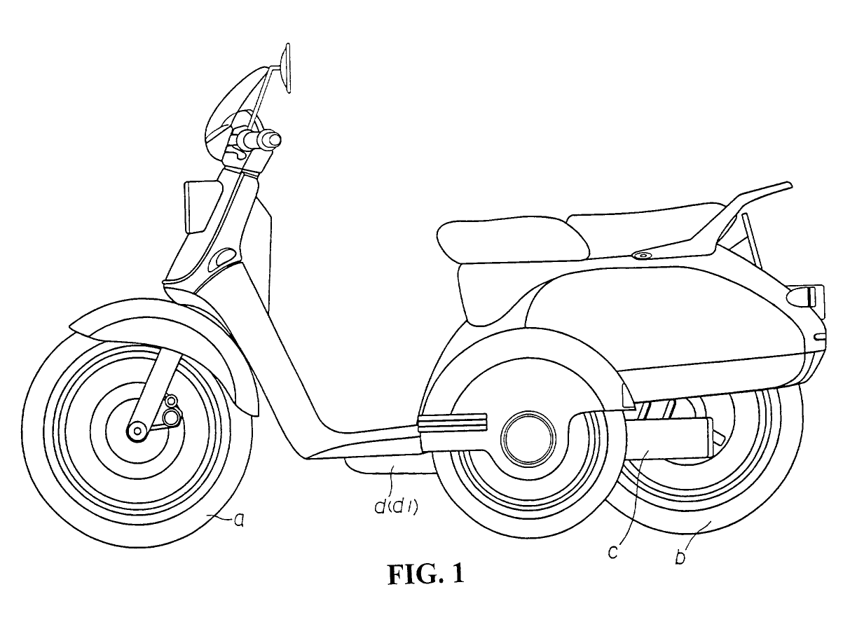

To make it easier for our examiner to understand the objective of the invention, structure, innovative features, and performance, we use a preferred embodiment together with the attached drawings for the detailed description of the invention. Please refer to FIGS. 1˜3 for the “improved motorcycle structure” according to a preferred embodiment of the present invention, which comprises a front wheel a, a back wheel b, an engine c, and a frame body d; the frame body d having a left horizontal frame and a right horizontal frame d1 at the bottom of the frame body, and a aslant pipe d2 being set backward on each of the horizontal frames, and the rear end of the two horizontal frame d1 being extended and welded onto the aslant pipe d2; a side wheel unit being disposed on the external side on both of the left and right horizontal frames d1. The side wheel unit comprises a connecting device 1, a contractible supporting base 2, and a side wheel 3′ wherein the connecting device 1 comprising a front fixing base 11 and a back fixing base 12 fixed in the horizontal frame d1 and an adjusting base 13 fixed between the two fixing bases; a sliding axle 14; the front fixing base 11 and the adjusting base 13 respectively having a through hole 111, 131, and the back fixing base 12 having a hole 121; the front fixing base 11 could be a front protruding base 112 having a semicircular hole and being fixed to the horizontal frame d1; a corresponding semicircular lid 113 having a semicircular groove, which is coupled by passing a screw bolt 4 through the semicircular cover 113 and being secured into the front protruded base 112.

The contractible supporting base 2 has a pair of front and back foldable bushings 21, and the bushing 21 also has a through hole 211; a protruding member 22 having a through hole 221 and being protruded from its external side; two protruded brackets 23 having a through hole 231, and being extended upward from the top surface of the protruded member 22, which further comprising a link rod 24 having a spring 241 and a stairway like connecting axle 25, and a hole 242, each being set at the top surface and the bottom surface of the link rod 24, and the bottom of the link rod 241 is pivotally coupled between the two protruded brackets 23 at the top of the protruded member 22, and a screw bolt 4 passes through the through hole 231 of the two protruded brackets 23 and the through hole 242 at the bottom of the link rod 24; the top of the link rod 24 is pivotally coupled to the frame body d, and such structure lets the frame body d be disposed between the two horizontal frames d1 and being welded to the connecting frame d3. An upper connecting frame d4 is welded at the location above the two aslant pipes d2, and the bottom of a curved pipe d5 is welded and extended from both sides of the lower connecting frame d3, and the top of the curved pipe d5 is welded onto the upper connecting frame d4. A fixing base is disposed on the curved pipe d5 proximate to the upper connecting frame d4, and the fixing base 26 has two protruded brackets 23, which makes use of a screw bolt 4 to pass through the two protruded brackets 23 and pivotally couple to the top of the link rod 24 between the two protruded brackets 23. The coupling between the fixing base 26 and the curved pipe d5 makes use of two screw bolds 4 to pass through the through hole on the fixing base 26 to press against the curved pipe d5 for the positioning.

A through hole 31 is disposed in the middle of a side wheel 3. During the assembly, the sliding axle 14 passes through the through hole 111 of the fixing base 11, the through hole 21 of the bushing at the front side of the contractible supporting base 2, the through hole 131 of the adjusting base, the through hole 21 of the bushing 21 at the rear side, and the hole 121 of the back fixing base in sequence; wherein the adjusting base 13 makes use of two screw bolts 4 to pass through the through hole at the top side in order to press against the sliding axle 14 for the positioning. The front protruded base 112 of the front fixing base 11 and the semicircular cover 113 are also coupled; as long as the front end of the front fixing base 11 is covered by a panel and fixed by a screw bolt 4, the sliding axle 14 is secured in its position, and the connecting device 1 and the contractible supporting base 2 are also coupled. Further, the coupling of the contractible supporting base 2 and the side wheel 3 is accomplished by means of passing through the inner side of the through hole 221 of the protruded member 22 of the connecting axle base 25, such that the rear end of the connecting axle base 25 press against the rear side of the protruded member 22 until its front end passes through the protruded member 22 and comes out from the side wheel 3, and then coupled and secured by a screw nut 6.

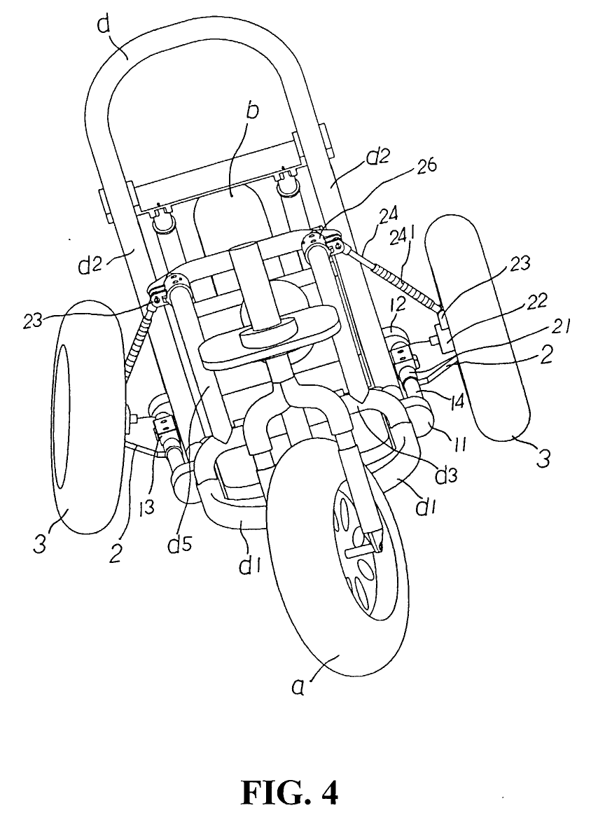

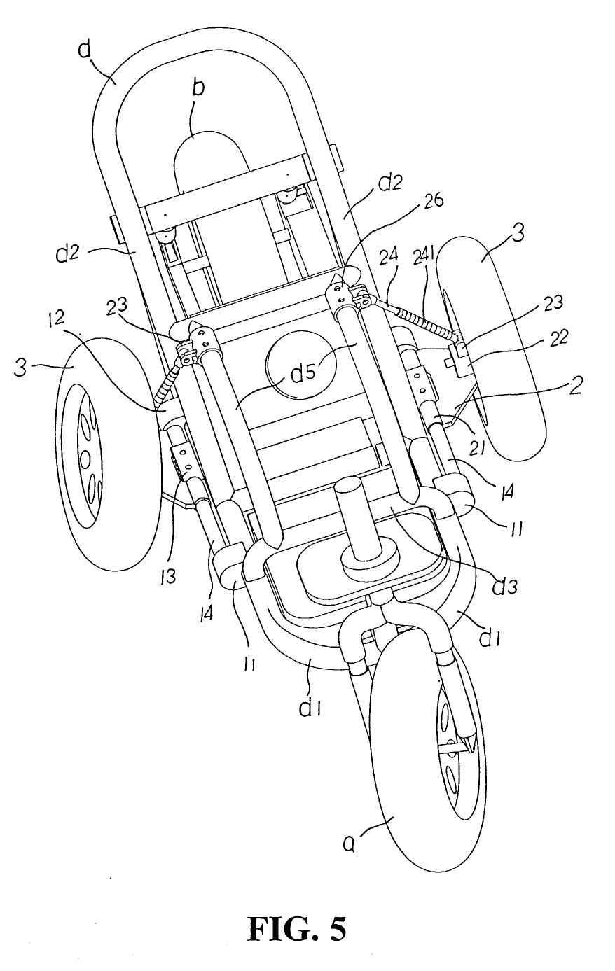

Since the foregoing assembly has two additional side wheels 3, it does not only improve the reliability of the driving, but also avoids to support the motorcycle by the rider's foot in front a red light during a rainy day, which is very convenient. Furthermore, when the motorcycle makes a turn (refer to FIGS. 4 and 5), the inner side of the turn for the link rod 24 of the contractible supporting base 2 can be shorted by the spring, and the outer side of the turn for the spring 241 on the link rod 24 will be elongated, so that the motorcycle can maintain a steady motion without the risk of being shaken, and thus keeps the stability and comfort of the driving.

The link rod 24 with a spring 241 of the contractible supporting base 2 could be substituted by the air compressed contractible rod, and any contractible rod is applicable for this purpose.

The present invention primaryily makes use of the two side wheel units disposed on the outer side of the horizontal frame d1, such that the motorcycle has a front wheel a, a back wheel b, and two side wheel units to increase the stability of the driving. The present invention can solve the following problems:

1. In a rainy, the motorcycle rider does not need to stand on the ground with a foot to support the motorcycle in front of a red light, and therefore the rider's foot will not get wet. It is mainly because the two additional side wheels increase the transversal area of the positioning.

2. The present invention can be used directly for the handicap's transportation without a need to remodel the existing motorcycle. The present invention has the basic conditions of four wheels and the inclination resisting function, which is applicable for the use by handicaps.

3. The existing motorcycle can be remodeled to the motorcycle according to the present invention very easily. The present invention uses the structure of the existing motorcycle for welding the frame and installs the side wheel units, and does not need to change or affect the entire motorcycle body.

4. The position of the front and back wheels can be adjusted according to the model of motorcycle. The related position of the adjusting base and the horizontal frame can be changed slightly to fit different models of motorcycles.

5. Although the present invention adds two side wheels, it will not increase the fuel consumption too much. It can greatly improve the safety, stability, and comfort of driving.

The present invention complies with the patentabilty, and hence submitted to the Patent and Trademark Office for review and granting of the commensurate patent rights.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An improved motorcycle structure, comprising a front wheel, a back wheel, an engine, and a frame body; the bottom of the frame body having a left horizontal frame and a right horizontal frame; an aslant pipe being set backward on the horizontal frame; the rear end of the two horizontal frames being extended and welded onto the aslant pipe; characterized in that a side wheel unit, each being disposed on the external side of the left and right horizontal frames, further comprising a connecting device, a contractible supporting base, and a side wheel; wherein the connecting device being used for pivotally coupling the contractible supporting base and horizontal frame, and the side wheel being used for pivotally coupled to the external side of the contractible supporting base; the contractible supporting base at least having one elastic rod such that the bottom of the elastic rod being pivotally coupled on the surface of the contractible supporting base; and the top of the rod being pivotally coupled to the upper section of the horizontal frame of the frame body of the motorcycle.

2. An improved motorcycle structure as claimed in claim 1, wherein said connecting device comprising a front fixing base and a back fixing base fixed to the horizontal frame; an adjusting base disposed between two fixing bases; and a sliding axle; the contractible supporting base having two complementary bushings corresponsive to both sides of the adjusting base; the sliding axle passing through the through hole of the front fixing base, and passing through the bushing in the front end of the contractible supporting base, the through hole of the adjusting base, the bushing at the rear of the contractible supporting base, and the hole of the back fixing base for securing them into position.

3. An improved motorcycle structure as claimed in claim 2, wherein said adjusting base comprising two screw holes on its top side, for fixing the sliding axle by a screw bolt after the sliding axle being positioned.

4. An improved motorcycle structure as claimed in claim 2, wherein said front fixing base at its front end having a panel for the covering after the sliding axle being positioned, and being fixed by a screw bolt.

5. An improved motorcycle structure as claimed in claim 1, wherein said contractible rod, contractible supporting base, and frame body being coupled by passing a screw bolt through two protruded brackets having through holes respectively on the contractible supporting bas and the frame body, and also passing through the through holes on the top side and bottom side of the contractible rod; and the contractile rod being pivotally latched between the two protruded brackets.

6. An improved motorcycle structure as claimed in claim 5, wherein said two protruded brackets of the contractible supporting base being disposed on the top side of the protruded member on the lateral side of the corresponsive side wheel, and the protruded member having a through hole corresponsive to the side wheel for passing a stairway shaped connecting axle base from the inside such that the rear end of the connecting axle base being pressed against the inner side of the protruded member; the front end passing through the protruded member and coming out from the side wheel, and being fixed by a coupling element.

7. An improved motorcycle structure as claimed in claim 6, wherein said body frame between the two horizontal frames having a coupling frame welded; an upper connecting frame being welded on the upper section of the two aslant pipes; a bottom of the curve pipe being welded and coupled onto both sides of the lower connecting frame; and the top end of the curved pipe being welded and coupled to the upper connecting frame.

8. An improved motorcycle structure as claimed in claim 7, wherein said curved pipe of the upper connecting frame having a fixing base, and the two protruded brackets of the frame body being fixed to the fixing base.

9. An improved motorcycle structure as claimed in claim 1, wherein said contractible rod of the contractible supporting base being a link rod with a spring or an air compressed contractible rod.
